(19) United States
(12) Patent Application Publication
(10) Pub. No.: US 2014/0354785 A1
(43) Pub. Date: Dec. 4, 2014

(54) METHOD OF PROVIDING A CORRECT 3D IMAGE FOR A VIEWER AT DIFFERENT WATCHING ANGLES OF THE VIEWER

(71) Applicant: C VISION TECHNOLOGY CO., LTD., SHENZHEN (CN)

(72) Inventors: TSUNG-YAU FANG, TAO YUN (TW); CHING-TE SHIH, KAOHSIUNG CITY (TW)

(73) Assignee: C VISION TECHNOLOGY CO., LTD., SHENZHEN (CN)

(21) Appl. No.: 14/094,853

(22) Filed: Dec. 3, 2013

(30) Foreign Application Priority Data
May 29, 2013 (TW) 102118935

(51) Int. Cl. H04N 13/04

(52) U.S. Cl. CPC H04N 13/0402
USPC 348/51

(57) ABSTRACT

A method of providing a correct 3D image for a viewer at different watching angles includes: providing an autostereoscopic 3D display for concurrently generating a left-eye image and a right-eye image; capturing the position of a left eye and a right eye of the viewer by a built-in image capturing module to obtain a real-time watching angle of the viewer with respect to the autostereoscopic 3D display; and determining whether the real-time watching angle is in a first or a second predetermined range. When the real-time watching angle is in the first predetermined range, the left-eye image and the right-eye image are respectively received by the left eye and the right eye of the viewer. When the real-time watching angle is in the second predetermined range, the right-eye image and the left-eye image are respectively received by the left eye and the right eye of the viewer.

### BACKGROUND OF THE INVENTION

1. Field of the Invention

The instant disclosure relates to a method of providing a correct 3D image for a viewer, and more particularly to a control device and a method of providing a correct 3D image for a viewer at different watching angles of the viewer.

2. Description of Related Art

Generally, stereoscopic images with three-dimensional (3D) effects are possible based on the theory of stereo-eyesight by both eyes. An important factor for a three dimensional effect is the difference in optical angles of a person's two eyes, due to a distance of 65 mm therebetween, i.e., a parallax of the eyes. That is, each of the eyes respectively sees two different two-dimensional images, and when said two images are transferred via retina to the brain, the brain combines said transferred two images and reproduces the original three-dimensional image with sense of depth and sense of reality. This is generally referred to stereography.

A stereoscopic image display apparatus is classified into two generic types based on whether a user should wear a specific pair of glasses or not: a glasses-type of stereoscopic image display apparatus (stereoscopic image display apparatus) and a non-glasses-type of stereoscopic image display apparatus (auto-stereoscopic image display apparatus). The stereoscopic image display apparatus gives a watcher inconvenience of wearing special glasses, while the auto-stereoscopic image display apparatus allows a watcher to enjoy three-dimensional images only by directly watching the screen even without wearing said glasses, and thereby the auto-stereoscopic image display apparatus solves problems with the stereoscopic image display apparatus. Therefore, there are many studies on the auto-stereoscopic image display apparatus going on nowadays. The auto-stereoscopic image display apparatus again can be classified into two generic types: apparatus by the lenticular method and apparatus by the parallax-barrier method.

Operation of the stereoscopic image display apparatus by the conventional parallax-barrier method are explained as follows. The stereoscopic image display apparatus by the conventional parallax-barrier method comprises a display module, wherein the left image and the right image respectively corresponding to the left eye and the right eye face towards the vertical direction and are disposed alternately in the horizontal direction; and a blocking film in the form of a bar which is called a barrier, disposed at the front end and facing towards the vertical direction. This kind of stereoscopic image display apparatus has a system wherein said display module and barrier are disposed so as that the light for the left image goes only into the left eye, and the light for the right image goes only into the right eye, and thereby the divided two left and right images are separately observed to give the stereoscopic sense.

### SUMMARY OF THE INVENTION

One aspect of the instant disclosure relates to a method of providing a correct 3D image for a viewer at different watching angles of the viewer.

One of the embodiments of the instant disclosure provides a method of providing a correct 3D image for a viewer at different watching angles of the viewer, comprising the steps of: providing an autostereoscopic 3D display having a screen surface for concurrently generating a left-eye image and a right-eye image for the viewer; capturing the position of a left eye and a right eye of the viewer by a built-in image capturing module on the autostereoscopic 3D display to define a standard watching angle of the viewer with respect to the screen surface of the autostereoscopic 3D display as 90 degrees while the viewer facing the autostereoscopic 3D display at 90 degrees relative to the screen surface of the autostereoscopic 3D display; capturing the position of the left eye and the right eye of the viewer by the built-in image capturing module to obtain a real-time watching angle of the viewer with respect to the screen surface of the autostereoscopic 3D display while the viewer facing the autostereoscopic 3D display at the real-time watching angle relative to the screen surface of the autostereoscopic 3D display; and the determining whether the real-time watching angle is 90°±Xθ or 90°±Yθ, wherein X is an odd number, Y is an even number and θ is a predetermined offset angle.

Furthermore, when the real-time watching angle of the viewer with respect to the screen surface of the autostereoscopic 3D display is 90°±Xθ, the left-eye image and the right-eye image concurrently generated from the autostereoscopic 3D display are respectively received by the left eye and the right eye of the viewer. When the real-time watching angle of the viewer with respect to the screen surface of the autostereoscopic 3D display is 90°±Yθ, the left-eye image and the right-eye image are interchanged with each other, and the right-eye image and the left-eye image concurrently generated from the autostereoscopic 3D display are respectively received by the left eye and the right eye of the viewer.

More precisely, when the predetermined offset angle is 15 degrees, X=1, 3 and 5 and Y=2, 4 and 6, wherein when the real-time watching angle of the viewer with respect to the screen surface of the autostereoscopic 3D display is 90°±15X, the left-eye image and the right-eye image generated from the autostereoscopic 3D display are respectively received by the left eye and the right eye of the viewer, wherein when the real-time watching angle of the viewer with respect to the screen surface of the autostereoscopic 3D display is 90°±15Y, the left-eye image and the right-eye image are interchanged with each other, and the right-eye image and the left-eye image generated from the autostereoscopic 3D display are respectively received by the left eye and the right eye of the viewer.

More precisely, the method further comprises: defining an absolute zero position and an absolute zero angle of the autostereoscopic 3D display by a built-in gyroscope in the autostereoscopic 3D display while the viewer facing the autostereoscopic 3D display at 90 degrees relative to the screen surface of the autostereoscopic 3D display; and then capturing a real-time moving position relative to the absolute zero position and a real-time rotating angle relative to the absolute zero angle of the autostereoscopic 3D display by the built-in gyroscope to obtain the real-time watching angle of the viewer with respect to the screen surface of the autostereoscopic 3D display while the viewer facing the autostereoscopic 3D display at the real-time watching angle relative to the screen surface of the autostereoscopic 3D display.

More precisely, the autostereoscopic 3D display comprises a backlight module, a LCD panel and a 3D film. The LCD panel is disposed on the backlight module, wherein the LCD panel has a plurality of pixels arranged in a matrix, each pixel is composed of at least three subpixels, and the at least three subpixels respectively are a red subpixel, a green subpixel and a blue subpixel. The 3D film is disposed on the LCD panel, wherein the 3D film has a plurality of line pattern barriers, and three of the line pattern barriers are respectively defined as a first laminating alignment line, a second laminating alignment line and a third laminating alignment line. In addition, one of the at least three subpixels of the pixel adjacent to the upper-left corner of LCD panel is defined as a first laminating alignment point, one of the at least three subpixels of the pixel adjacent to the lower-left corner of LCD panel is defined as a second laminating alignment point, one of the at least three subpixels of the pixel adjacent to the upper-right corner of LCD panel is defined as a third laminating alignment point, and the first, the second and the third laminating alignment points are respectively and correspondingly aligned with the first, the second and the third laminating alignment lines.

Another one of the embodiments of the instant disclosure provides a method of providing a correct 3D image for a viewer at different watching angles of the viewer, comprising the steps of: providing an autostereoscopic 3D display having a screen surface for concurrently generating a left-eye image and a right-eye image for the viewer; capturing the position of a left eye and a right eye of the viewer by a built-in image capturing module on the autostereoscopic 3D display to obtain a real-time watching angle of the viewer with respect to the screen surface of the autostereoscopic 3D display; and then determining whether the real-time watching angle is in a first predetermined range or a second predetermined range, wherein the first and the second predetermined ranges are different. More precisely, when the real-time watching angle of the viewer with respect to the screen surface of the autostereoscopic 3D display is in the first predetermined range, the left-eye image and the right-eye image concurrently generated from the autostereoscopic 3D display are respectively received by the left eye and the right eye of the viewer. When the real-time watching angle of the viewer with respect to the screen surface of the autostereoscopic 3D display is in the second predetermined range, the left-eye image and the right-eye image are interchanged with each other, and the right-eye image and the left-eye image concurrently generated from the autostereoscopic 3D display are respectively received by the left eye and the right eye of the viewer.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1 shows a lateral, schematic view of the autostereoscopic 3D display of the instant disclosure;

FIG. 2 shows a top, schematic view of the LCD panel of the autostereoscopic 3D display of the instant disclosure;

FIG. 3 shows a top, schematic view of the 3D film of the autostereoscopic 3D display of the instant disclosure;

FIG. 4 shows a top, schematic view of the 3D film attaching to the LCD panel of the instant disclosure;

FIG. 5A shows an enlarged view taken on part A1 of FIG. 4;

FIG. 5B shows an enlarged view taken on part A2 of FIG. 4;

FIG. 5C shows an enlarged view taken on part A3 of FIG. 4;

FIG. 5D shows an enlarged view taken on part A4 of FIG. 4;

FIG. 5E shows an enlarged view taken on part A5 of FIG. 4;

FIG. 6 shows a flowchart of a method of manufacturing the autostereoscopic 3D display of the instant disclosure;

FIG. 7 shows a lateral, schematic view of the step S108 of the method of manufacturing the autostereoscopic 3D display of the instant disclosure;

FIG. 8 shows a flowchart of another method of manufacturing the autostereoscopic 3D display of the instant disclosure;

FIG. 9 shows a lateral, schematic view of the step S206 of the method of manufacturing the autostereoscopic 3D display of the instant disclosure;

FIG. 10 shows a function block of the equipment for manufacturing the autostereoscopic 3D display of the instant disclosure;

FIG. 11 shows a schematic view of the optical cement coating machine of the equipment for manufacturing the autostereoscopic 3D display of the instant disclosure;

FIG. 12 shows a schematic view of the 3D film laminating mechanism of the equipment for manufacturing the autostereoscopic 3D display of the instant disclosure;

FIG. 13 shows a flowchart of the method of providing a correct 3D image for a viewer at different watching angles of the viewer according to the instant disclosure;

FIG. 14 shows a schematic view of the autostereoscopic 3D display for concurrently generating a left-eye image and a right-eye image for the viewer according to the instant disclosure;

FIG. 15 shows a schematic view of the viewer facing the autostereoscopic 3D display at 90 degrees relative to the screen surface of the autostereoscopic 3D display of the instant disclosure;

FIG. 16 shows a schematic view of capturing the position of the left eye and the right eye of the viewer by the built-in image capturing module to obtain a real-time watching angle as 135 degrees of the viewer with respect to the screen surface of the autostereoscopic 3D display of the instant disclosure;

FIG. 17 shows a schematic view of capturing the position of the left eye and the right eye of the viewer by the built-in image capturing module to obtain a real-time watching angle as 160 degrees of the viewer with respect to the screen surface of the autostereoscopic 3D display of the instant disclosure;

FIG. 18 shows a schematic view of capturing the position of the left eye and the right eye of the viewer by the built-in gyroscope to obtain a real-time watching angle as 135 degrees of the viewer with respect to the screen surface of the autostereoscopic 3D display of the instant disclosure; and

FIG. 19 shows a schematic view of capturing the position of the left eye and the right eye of the viewer by the built-in gyroscope to obtain a real-time watching angle as 160 degrees of the viewer with respect to the screen surface of the autostereoscopic 3D display of the instant disclosure.

### DETAILED DESCRIPTION OF THE PREFERRED EMBODIMENTS

### First Embodiment

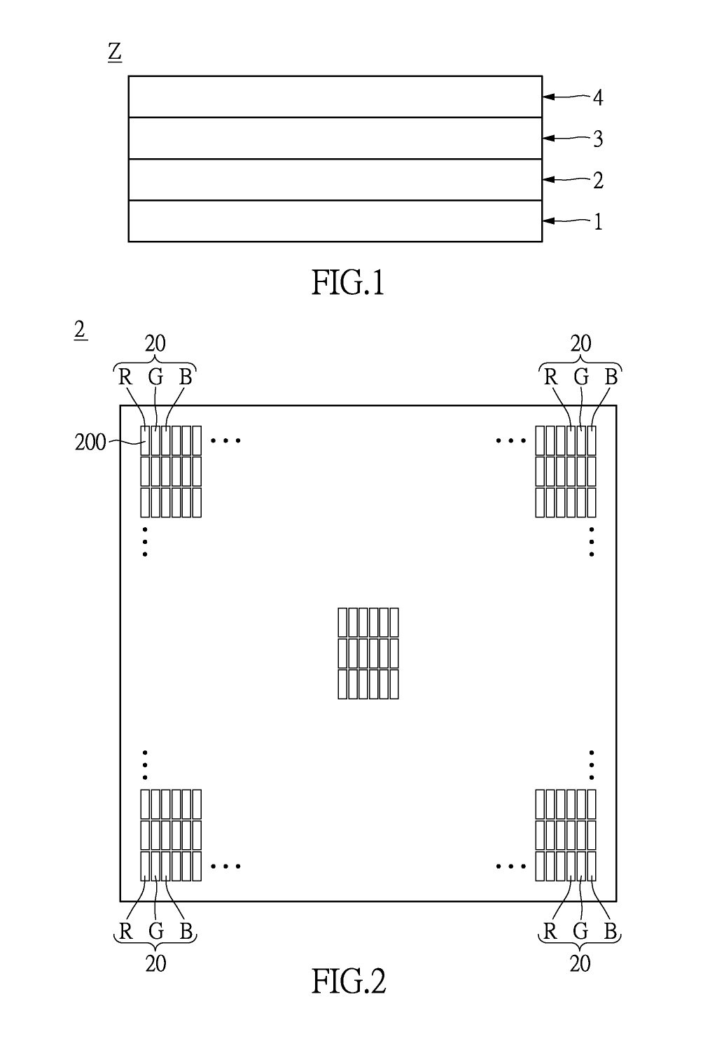

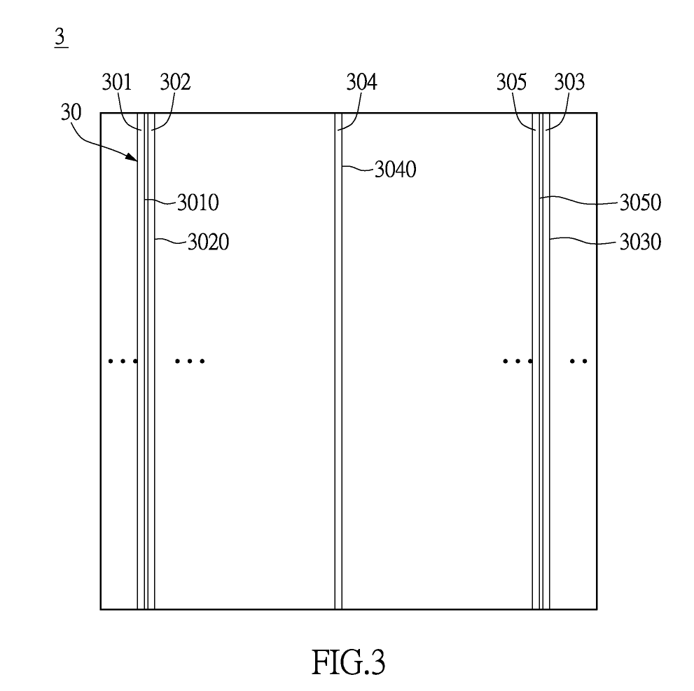

Referring to FIG. 1 to FIG. 4, where the first embodiment of the instant disclosure provides an autostereoscopic 3D display Z having a stereoscopic image display function, comprising: a backlight module 1, a LCD panel 2, a 3D film 3 (as a 3D pattern) and a touch panel 4 (such as a ITO transparent conductive film), and the backlight module 1, the LCD panel 2, the 3D film 3 and the touch panel 4 are stacked on top of one another from bottom to top. In addition, the 3D film 3 is used to provide a stereoscopic image display function for the autostereoscopic 3D display Z, and the touch panel 4 is used to provide a touch function for the autostereoscopic 3D display Z.

Moreover, referring to FIG. 1 and FIG. 2, the LCD panel 2 is disposed on the backlight module 1. The LCD panel 2 has a plurality of pixels 20 arranged in a matrix, each pixel 20 can be composed of at least three subpixels 200 (such as a color dot), and the at least three subpixels 200 may be a red subpixel R, a green subpixel G and a blue subpixel B, respectively. In addition, the 3D film 3 is disposed on the LCD panel 2. The 3D film has a plurality of line pattern barriers 30 such as a micro parallax barrier array (only some of the line pattern barriers 30 are shown in figures), and three of the line pattern barriers 30 can be respectively defined as a first laminating alignment line 301, a second laminating alignment line 302 and a third laminating alignment line 303.

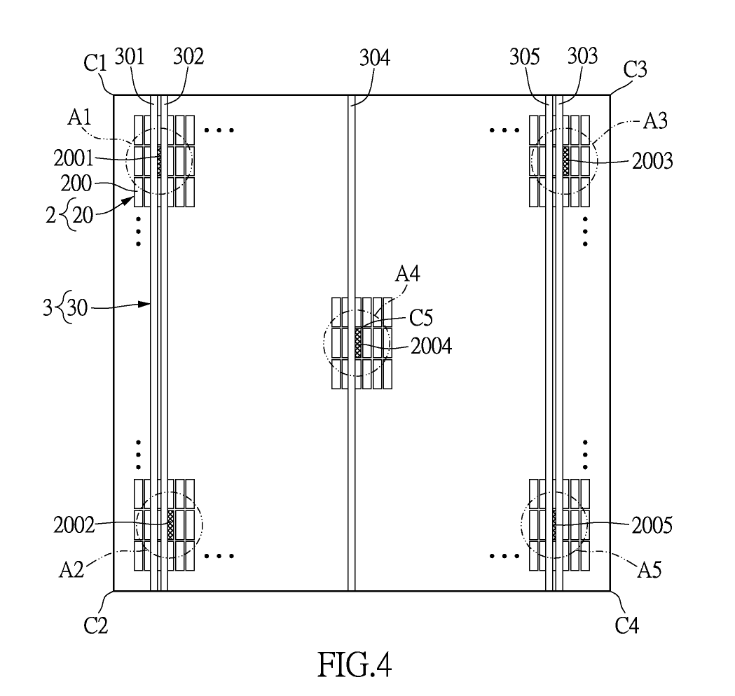

Furthermore, referring to FIG. 2 to FIG. 4, one of the at least three subpixels 200 of the pixel 20 (such as the blue subpixel B) that is adjacent to the upper-left corner C1 of the LCD panel 2 is defined as a first laminating alignment point 2001. One of the at least three subpixels 200 of the pixel 20 (such as the red subpixel R) that is adjacent to the lower-left corner C2 of the LCD panel 2 is defined as a second laminating alignment point 2002. One of the at least three subpixels 200 of the pixel 20 (such as the red subpixel R) that is adjacent to the upper-right corner C3 of the LCD panel 2 is defined as a third laminating alignment point 2003. Referring to FIG. 1 and FIG. 4, when the 3D film 3 is attached to the LCD panel 2, the first laminating alignment point 2001, the second laminating alignment point 2002 and the third laminating alignment point 2003 can be respectively and correspondingly aligned with the first laminating alignment line 301, the second laminating alignment line 302 and the third laminating alignment line 303, thus the 3D film 3 can be correctly aligned with the LCD panel 2 by matching the three laminating alignment points (2001, 2002, 2003) and the three laminating alignment lines (301, 302, 303).

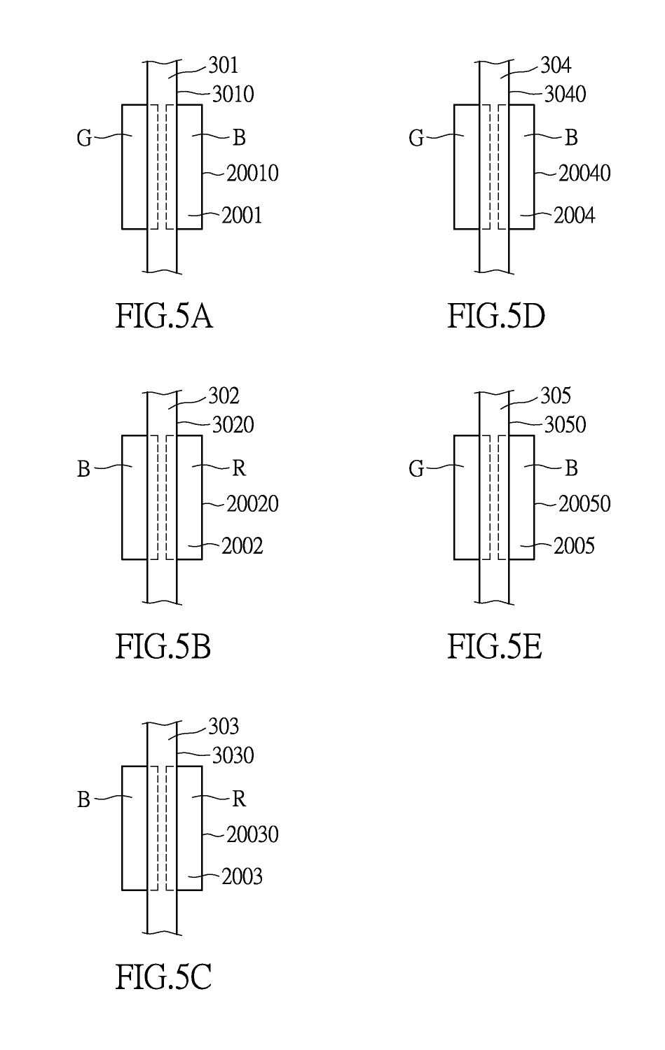

More precisely, referring to FIG. 4, FIG. 5A, FIG. 5B and FIG. 5C, where FIG. 5A shows an enlarged view taken on part A1 of FIG. 4, FIG. 5B shows an enlarged view taken on part A2 of FIG. 4, and FIG. 5C shows an enlarged view taken on part A3 of FIG. 4. When the 3D film 3 is adhesively disposed on the LCD panel 2, the first long lateral side 3010 of the first laminating alignment line 301 can be horizontally aligned with the first long lateral side 20010 of the first laminating alignment point 2001 (such as the blue subpixel B as shown in FIG. 5A), the second long lateral side 3020 of the second laminating alignment line 302 can be horizontally aligned with the second long lateral side 20020 of the second laminating alignment point 2002 (such as the red subpixel R as shown in FIG. 5B), and the third long lateral side 3030 of the third laminating alignment line 303 can be horizontally aligned with the third long lateral side 20030 of the third laminating alignment point 2003 (such as the red subpixel R as shown in FIG. 5C). Therefore, the first long lateral side 3010 of the first laminating alignment line 301, the second long lateral side 3020 of the second laminating alignment line 302, and the third long lateral side 3030 of the third laminating alignment line 303 can be respectively and horizontally aligned with the first long lateral side 20010 of the first laminating alignment point 2001, the second long lateral side 20020 of the second laminating alignment point 2002, and the third long lateral side 20030 of the third laminating alignment point 2003, thus the 3D film 3 can be correctly aligned with the LCD panel 2 by matching the three laminating alignment points (2001, 2002, 2003) and the three laminating alignment lines (301, 302, 303). In addition, one-third of the area of the laminating alignment point (2001, 2002 or 2003) is substantially covered by the corresponding laminating alignment line (301, 302 or 303).

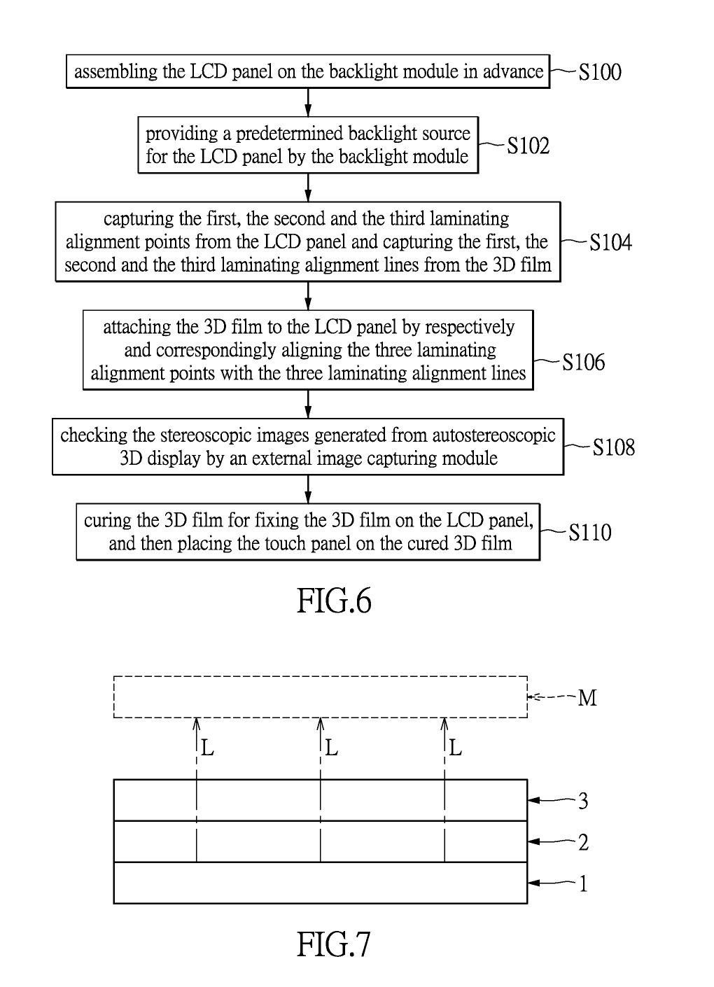

Referring to FIG. 1, FIG. 4, FIG. 6 and FIG. 7, where the first embodiment of the instant disclosure provides a method of manufacturing an autostereoscopic 3D display Z, comprising the steps of: assembling the LCD panel 2 on the backlight module 1 in advance (S100); providing a predetermined backlight source L for the LCD panel 2 (and the 3D film 3) by the backlight module 1 (S102); capturing the first laminating alignment point 2001, the second laminating alignment point 2002 and the third laminating alignment point 2003 from the LCD panel 2 and capturing the first laminating alignment line 301, the second laminating alignment line 302 and the third laminating alignment line 303 from the 3D film 3 (S104); attaching the 3D film 3 to the LCD panel 2 by respectively and correspondingly aligning the three laminating alignment points (2001, 2002, 2003) with the three laminating alignment lines (301, 302, 303) as shown in FIG. 4 (S106); checking the stereoscopic images generated from autostereoscopic 3D display Z by an external image capturing module M as shown in FIG. 7 (S108); and curing the 3D film 3 for fixing the 3D film 3 on the LCD panel 2, and then placing the touch panel 4 on the cured 3D film 3 (S110).

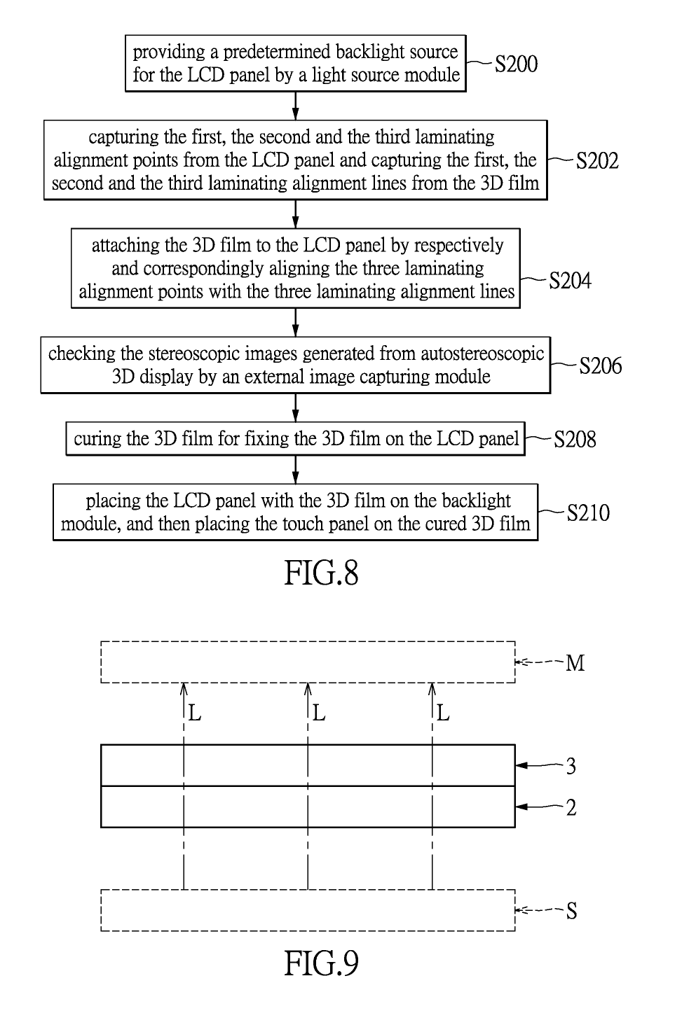

Referring to FIG. 1, FIG. 4, FIG. 8 and FIG. 9, where the first embodiment of the instant disclosure provides another method of manufacturing an autostereoscopic 3D display Z, comprising the steps of: providing a predetermined backlight source L for the LCD panel 2 (and the 3D film 3) by a light source module S (S200); capturing the first laminating alignment point 2001, the second laminating alignment point 2002 and the third laminating alignment point 2003 from the LCD panel 2 and capturing the first laminating alignment line 301, the second laminating alignment line 302 and the third laminating alignment line 303 from the 3D film 3 (S202); attaching the 3D film 3 to the LCD panel 2 by respectively and correspondingly aligning the three laminating alignment points (2001, 2002, 2003) with the three laminating alignment lines (301, 302, 303) as shown in FIG. 4 (S204); checking the stereoscopic images generated from autostereoscopic 3D display Z by an external image capturing module M as shown in FIG. 9 (S206); curing the 3D film 3 for fixing the 3D film 3 on the LCD panel 2 (S208); and placing the LCD panel 2 with the 3D film 3 on the backlight module 1, and then placing the touch panel 4 on the cured 3D film 3 (S210).

### Second Embodiment

Referring to FIG. 4 to FIG. 5D, the difference between the second embodiment and the first embodiment is as follows: in the second embodiment, another one of the line pattern barriers 30 is defined as a fourth laminating alignment line 304, one of the at least three subpixels 200 of the pixel 20 (such as the blue subpixel B) that is adjacent to the center C5 of LCD panel 2 is defined as a fourth laminating alignment point 2004, and the fourth laminating alignment point 2004 can be correspondingly aligned with the fourth laminating alignment line 304.

More precisely, referring to FIG. 4, FIG. 5A to FIG. 5D, the first long lateral side 3010 of the first laminating alignment line 301, the second long lateral side 3020 of the second laminating alignment line 302, the third long lateral side 3030 of the third laminating alignment line 303, and the fourth long lateral side 3040 of the fourth laminating alignment line 304 can be respectively and horizontally aligned with the first long lateral side 20010 of the first laminating alignment point 2001, the second long lateral side 20020 of the second laminating alignment point 2002, the third long lateral side 20030 of the third laminating alignment point 2003, and the fourth long lateral side 20040 of the fourth laminating alignment point 2004. Hence, referring to FIG. 1 and FIG. 4, when the 3D film 3 is attached to the LCD panel 2, the first laminating alignment point 2001, the second laminating alignment point 2002, the third laminating alignment point 2003 and the fourth laminating alignment point 2004 can be respectively and correspondingly aligned with the first laminating alignment line 301, the second laminating alignment line 302, the third laminating alignment line 303 and the fourth laminating alignment line 304, thus the 3D film 3 can be correctly aligned with the LCD panel 2 by matching the four laminating alignment points (2001, 2002, 2003, 2004) and the four laminating alignment lines (301, 302, 303, 304).

### Third Embodiment

Referring to FIG. 4 to FIG. 5E, the difference between the third embodiment and the second embodiment is as follows: in the third embodiment, yet another one of the line pattern barriers 30 is defined as a fifth laminating alignment line 305, one of the at least three subpixels 200 of the pixel 20 (such as the blue subpixel B) that is adjacent to the lower-right corner C4 of LCD panel 2 is defined as a fifth laminating alignment point 2005, and the fifth laminating alignment point 2005 can be correspondingly aligned with the fifth laminating alignment line 305.

More precisely, referring to FIG. 4, FIG. 5A to FIG. 5E, the first long lateral side 3010 of the first laminating alignment line 301, the second long lateral side 3020 of the second laminating alignment line 302, the third long lateral side 3030 of the third laminating alignment line 303, the fourth long lateral side 3040 of the fourth laminating alignment line 304, and the fifth long lateral side 3050 of the fifth laminating alignment line 305 can be respectively and horizontally aligned with the first long lateral side 20010 of the first laminating alignment point 2001, the second long lateral side 20020 of the second laminating alignment point 2002, the third long lateral side 20030 of the third laminating alignment point 2003, the fourth long lateral side 20040 of the fourth laminating alignment point 2004, and the fifth long lateral side 20050 of the fifth laminating alignment point 2005. Hence, referring to FIG. 1 and FIG. 4, when the 3D film 3 is attached to the LCD panel 2, the first laminating alignment point 2001, the second laminating alignment point 2002, the third laminating alignment point 2003, the fourth laminating alignment point 2004 and the fifth laminating alignment point 2005 can be respectively and correspondingly aligned with the first laminating alignment line 301, the second laminating alignment line 302, the third laminating alignment line 303, the fourth laminating alignment line 304 and the fifth laminating alignment line 305, thus the 3D film 3 can be correctly aligned with the LCD panel 2 by matching the five laminating alignment points (2001, 2002, 2003, 2004, 2005) and the five laminating alignment lines (301, 302, 303, 304, 305).

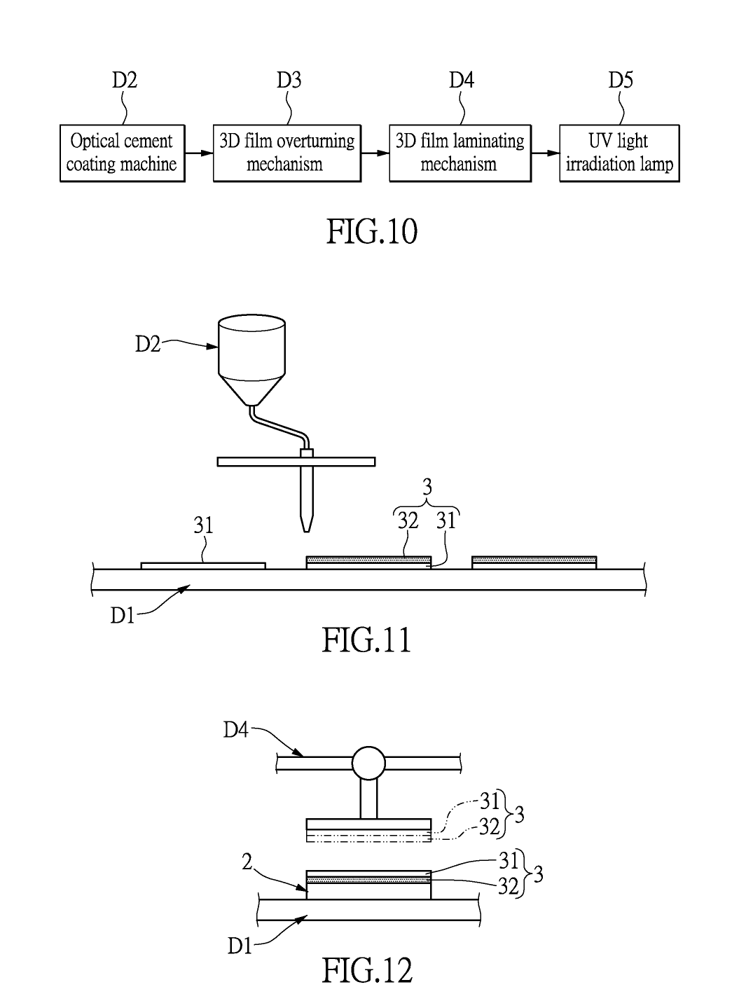

More precisely, referring to FIG. 10 and FIG. 11, the 3D film 3 includes a base 31 and an optical cement 32 (such as a liquid optical clear adhesive) coated on the top surface of the base 31 by the optical cement coating machine D2. More precisely, the bases 31 can be sequentially transported to the optical cement coating machine D2, thus the optical cement 32 can be coated on each base 31 by the optical cement coating machine D2. Referring to FIG. 10 and FIG. 12, after the optical cement 32 is coated on each base 31 by the optical cement coating machine D2, the 3D film 3 can be overturned by the 180° overturning mechanism D3, thus the optical cement 32 is disposed under the base 31. In addition, referring to FIG. 12, after the 3D film 3 is overturned by the 180° overturning mechanism D3, the 3D film 3 can be attached to the LCD panel 2 by the 3D film laminating mechanism D4 (such as a nozzle). Finally, after the 3D film 3 is adhesively disposed on the LCD panel 2 by the 3D film laminating mechanism D4, curing the 3D film 3 for fixing the 3D film 3 on the LCD panel 2.

### Fourth Embodiment

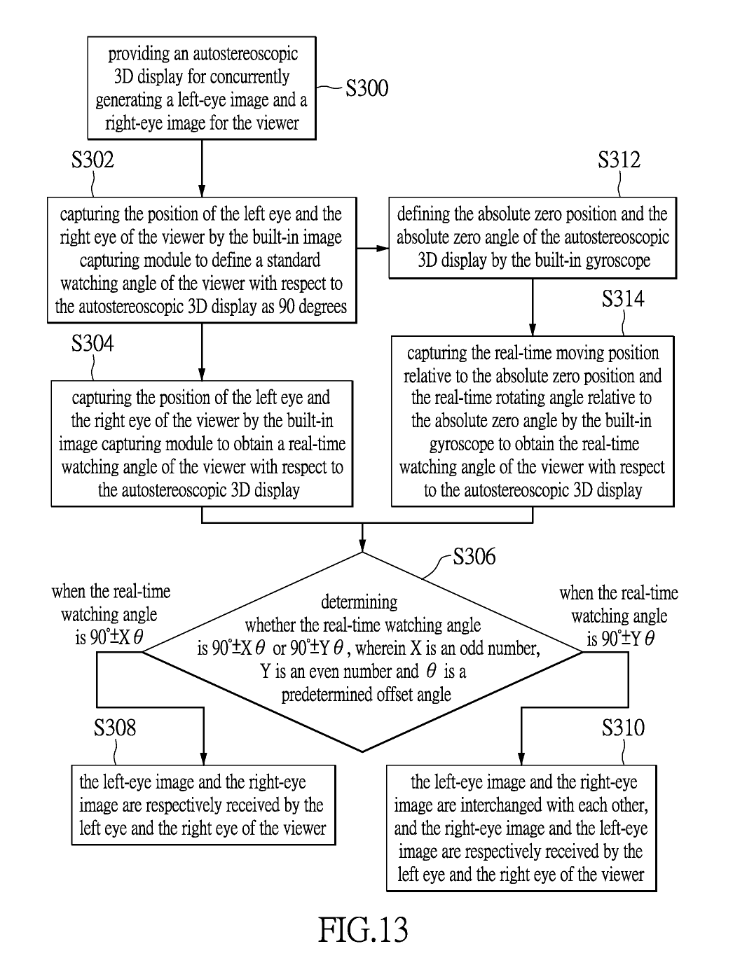

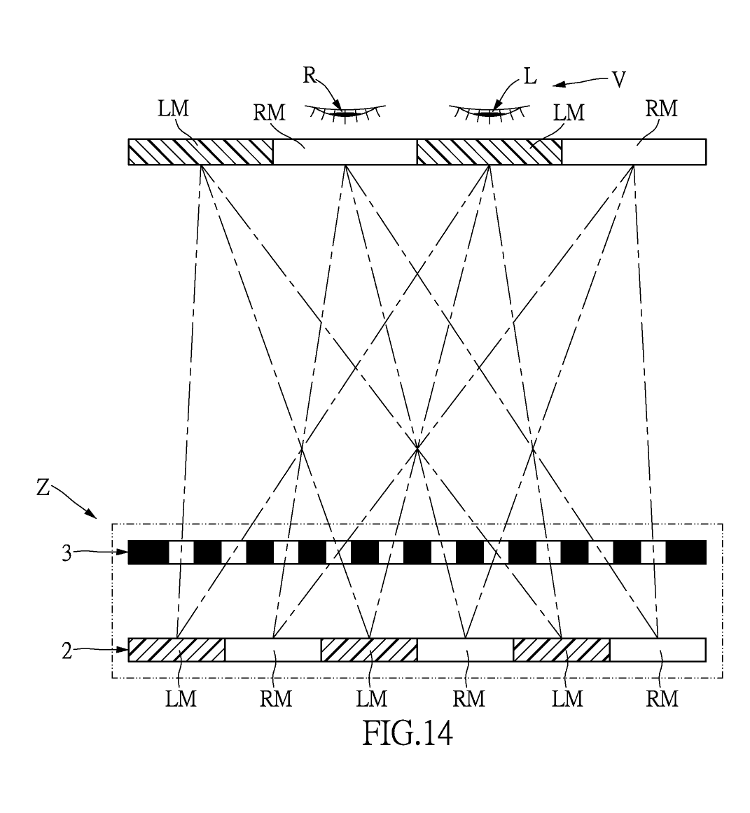

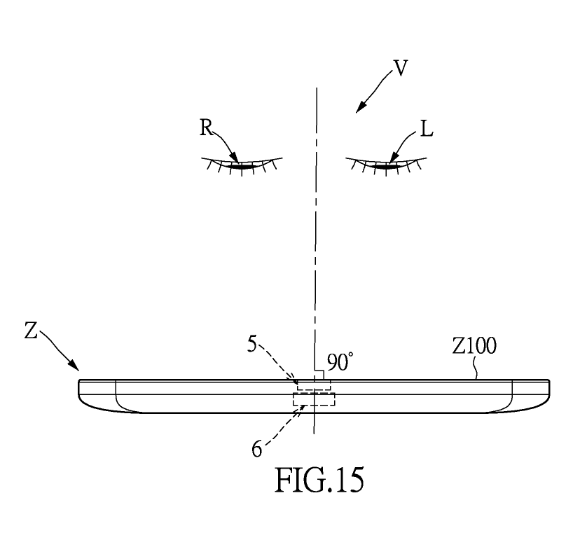

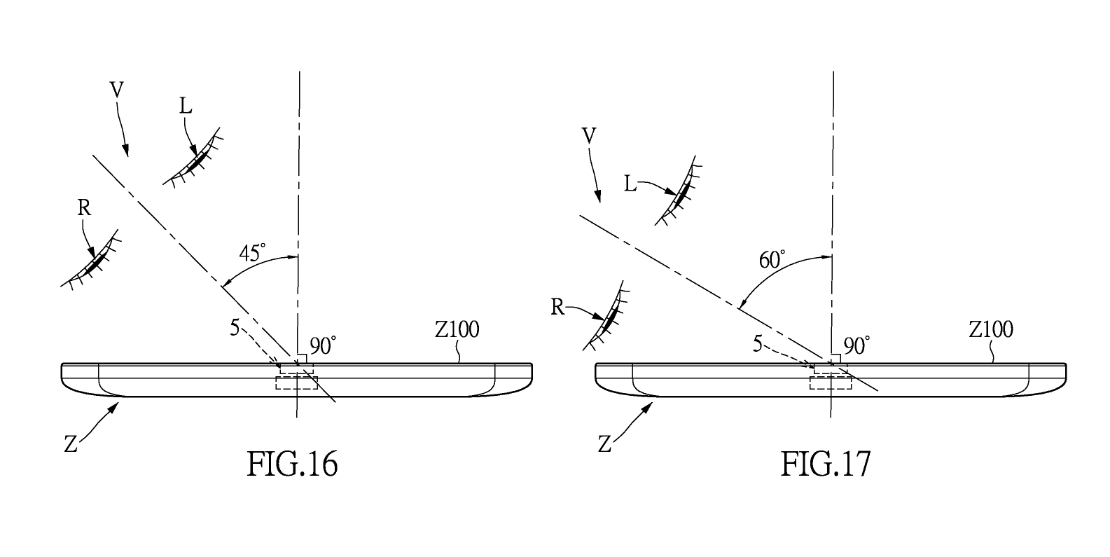

Referring to FIG. 13 to FIG. 17, where the fourth embodiment of the instant disclosure provides a method of providing a correct 3D image for a viewer V at different watching angles of the viewer V, comprising the step of: first, referring to FIG. 13 and FIG. 14, providing an autostereoscopic 3D display Z having a screen surface Z100 for concurrently generating a left-eye image LM and a right-eye image RM for the viewer V (S300); next, referring to FIG. 13 to FIG. 15, capturing the position of a left eye L and a right eye R of the viewer V by a built-in image capturing module 5 (such as a built-in digital camera) on the autostereoscopic 3D display Z to define a standard watching angle of the viewer V with respect to (or relative to) the screen surface Z100 of the autostereoscopic 3D display Z as 90 degrees while the viewer V facing the autostereoscopic 3D display Z at 90 degrees relative to the screen surface Z100 of the autostereoscopic 3D display Z (S302); afterward, referring to FIG. 13, FIG. 16 and FIG. 17, capturing the position of the left eye L and the right eye R of the viewer V by the built-in image capturing module 5 to obtain a real-time watching angle of the viewer V with respect to the screen surface Z100 of the autostereoscopic 3D display Z while the viewer V facing the autostereoscopic 3D display Z at the real-time watching angle relative to the screen surface Z100 of the autostereoscopic 3D display Z (S304); and then, referring to FIG. 13, determining whether the real-time watching angle is 90°±Xθ or 90°±Yθ, wherein X is an odd number, Y is an even number and θ is a predetermined offset angle (S306). More precisely, when the real-time watching angle of the viewer V with respect to the screen surface Z100 of the autostereoscopic 3D display Z is 90°±Xθ, the left-eye image LM and the right-eye image RM concurrently generated from the autostereoscopic 3D display Z are respectively received by the left eye L and the right eye R of the viewer V (i.e., the left-eye image LM and the right-eye image RM can be respectively projected onto the left eye L and the right eye R of the viewer V as shown in FIG. 14) (S308). When the real-time watching angle of the viewer V with respect to the screen surface Z100 of the autostereoscopic 3D display Z is 90°±Yθ, the left-eye image LM and the right-eye image RM are interchanged with each other, and the right-eye image RM and the left-eye image LM concurrently generated from the autostereoscopic 3D display Z are respectively received by the left eye L and the right eye R of the viewer V (i.e., the right-eye image RM and the left-eye image LM can be respectively projected onto the left eye L and the right eye R of the viewer V) (S310).

For example, if the predetermined offset angle is 15 degrees, X=1, 3 and 5, and Y=2, 4 and 6. Hence, referring to FIG. 16, when the real-time watching angle of the viewer V with respect to the screen surface Z100 of the autostereoscopic 3D display Z is 135°, the instant disclosure can determine that the real-time watching angle of the viewer V with respect to the screen surface Z100 of the autostereoscopic 3D display Z is 90°±15X and X=3 (i.e., 90°±15×3=135°), thus the left-eye image LM and the right-eye image RM generated from the autostereoscopic 3D display Z are respectively received by the left eye L and the right eye R of the viewer V. In addition, referring to FIG. 17, when the real-time watching angle of the viewer V with respect to the screen surface Z100 of the autostereoscopic 3D display Z is 150°, the instant disclosure can determine that the real-time watching angle of the viewer V with respect to the screen surface Z100 of the autostereoscopic 3D display Z is 90°±15Y and Y=4 (i.e., 90°±15×4=150°), thus the left-eye image LM and the right-eye image RM are interchanged with each other, and the right-eye image RM and the left-eye image LM generated from the autostereoscopic 3D display Z are respectively received by the left eye L and the right eye R of the viewer V.

In other words, the fourth embodiment of the instant disclosure provides a method of providing a correct 3D image for a viewer V at different watching angles of the viewer V, comprising the step of: first, providing an autostereoscopic 3D display Z having a screen surface Z100 for concurrently generating a left-eye image LM and a right-eye image RM for the viewer V; next, capturing the position of a left eye L and a right eye R of the viewer V by a built-in image capturing module 5 on the autostereoscopic 3D display Z to obtain a real-time watching angle of the viewer V with respect to the screen surface Z100 of the autostereoscopic 3D display Z; and then determining whether the real-time watching angle is in a first predetermined range or a second predetermined range, wherein the first and the second predetermined ranges are different. In addition, when the real-time watching angle of the viewer V with respect to the screen surface Z100 of the autostereoscopic 3D display Z is in the first predetermined range, the left-eye image LM and the right-eye image RM concurrently generated from the autostereoscopic 3D display Z are respectively received by the left eye L and the right eye R of the viewer V. Furthermore, when the real-time watching angle of the viewer V with respect to the screen surface Z100 of the autostereoscopic 3D display Z is in the second predetermined range, the left-eye image LM and the right-eye image RM are interchanged with each other, and the right-eye image RM and the left-eye image LM concurrently generated from the autostereoscopic 3D display Z are respectively received by the left eye L and the right eye R of the viewer V.

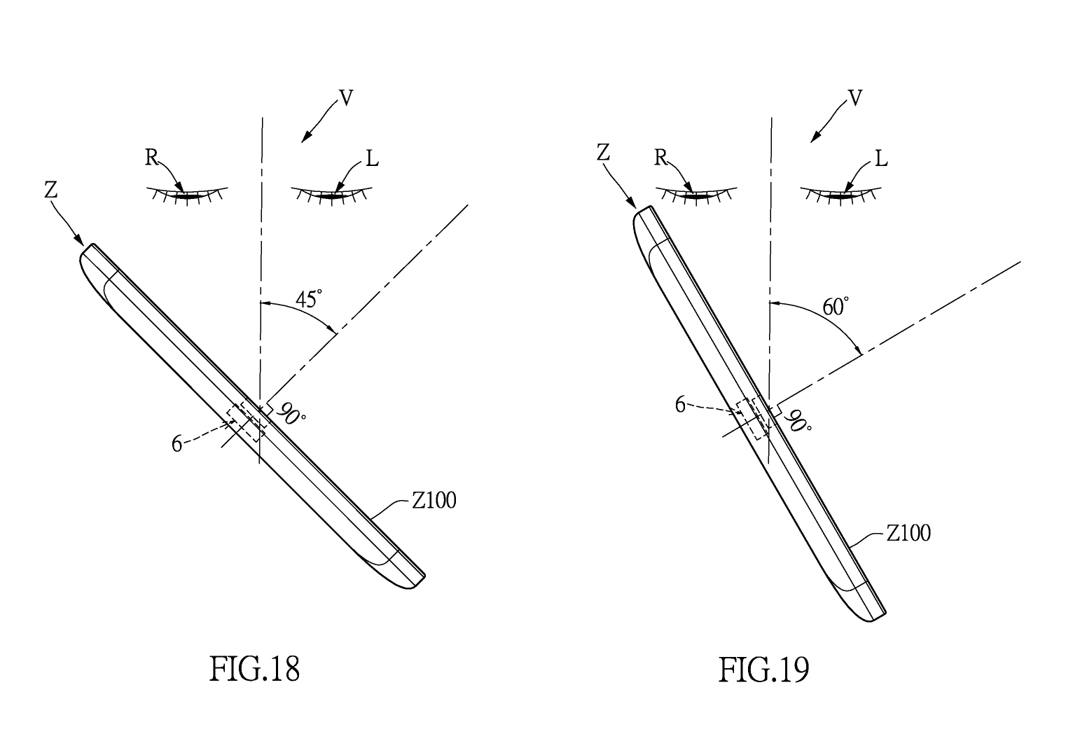

More precisely, referring to FIG. 18 and FIG. 19, the method of providing a correct 3D image for the viewer V at different watching angles of the viewer V further comprises the step of: referring to FIG. 13 and FIG. 15, defining an absolute zero position and an absolute zero angle of the autostereoscopic 3D display Z relative to the viewer V by a built-in gyroscope 6 (such as a MEMS gyroscope chip) in the autostereoscopic 3D display Z while the viewer V facing the autostereoscopic 3D display Z at 90 degrees relative to the screen surface Z100 of the autostereoscopic 3D display Z (S312); and then, capturing a real-time moving position relative to the absolute zero position and a real-time rotating angle relative to the absolute zero angle of the autostereoscopic 3D display Z relative to the viewer V by the built-in gyroscope 6 to obtain the real-time watching angle of the viewer V with respect to the screen surface Z100 of the autostereoscopic 3D display Z while the viewer V facing the autostereoscopic 3D display Z at the real-time watching angle relative to the screen surface Z100 of the autostereoscopic 3D display Z (S314).

For example, referring to FIG. 18, when the real-time watching angle of the viewer V with respect to the screen surface Z100 of the autostereoscopic 3D display Z is 135°, the instant disclosure can determine that the real-time watching angle of the viewer V with respect to the screen surface Z100 of the autostereoscopic 3D display Z is 90°±15X and X=3 (i.e., 90°±15×3=135°, thus the left-eye image LM and the right-eye image RM generated from the autostereoscopic 3D display Z are respectively received by the left eye L and the right eye R of the viewer V. In addition, referring to FIG. 17, when the real-time watching angle of the viewer V with respect to the screen surface Z100 of the autostereoscopic 3D display Z is 150°, the instant disclosure can determine that the real-time watching angle of the viewer V with respect to the screen surface Z100 of the autostereoscopic 3D display Z is 90°±15Y and Y=4 (i.e., 90°±15×4=150°), thus the left-eye image LM and the right-eye image RM are interchanged with each other, and the right-eye image RM and the left-eye image LM generated from the autostereoscopic 3D display Z are respectively received by the left eye L and the right eye R of the viewer V.

In conclusion, because (1) “the left-eye image LM and the right-eye image RM concurrently generated from the autostereoscopic 3D display Z are respectively received by the left eye L and the right eye R of the viewer V while the real-time watching angle of the viewer V with respect to the screen surface Z100 of the autostereoscopic 3D display Z is in the first predetermined range” and (2) “the right-eye image RM and the left-eye image LM concurrently generated from the autostereoscopic 3D display Z are respectively received by the left eye L and the right eye R of the viewer V while the real-time watching angle of the viewer V with respect to the screen surface Z100 of the autostereoscopic 3D display Z is in the second predetermined range”, the method of the instant disclosure can be applied to provide a correct 3D image for a viewer V at different watching angles of the viewer V.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. A method of providing a correct 3D image for a viewer at different watching angles of the viewer, comprising:
providing an autostereoscopic 3D display having a screen surface for concurrently generating a left-eye image and a right-eye image for the viewer;
capturing the position of a left eye and a right eye of the viewer by a built-in image capturing module on the autostereoscopic 3D display to define a standard watching angle of the viewer with respect to the screen surface of the autostereoscopic 3D display as 90 degrees while the viewer facing the autostereoscopic 3D display at 90 degrees relative to the screen surface of the autostereoscopic 3D display;
capturing the position of the left eye and the right eye of the viewer by the built-in image capturing module to obtain a real-time watching angle of the viewer with respect to the screen surface of the autostereoscopic 3D display while the viewer facing the autostereoscopic 3D display at the real-time watching angle relative to the screen surface of the autostereoscopic 3D display; and
determining whether the real-time watching angle is 90°±Xθ or 90°±Yθ, wherein X is an odd number, Y is an even number and θ is a predetermined offset angle;
wherein when the real-time watching angle of the viewer with respect to the screen surface of the autostereoscopic 3D display is 90°±Xθ, the left-eye image and the right-eye image concurrently generated from the autostereoscopic 3D display are respectively received by the left eye and the right eye of the viewer;
wherein when the real-time watching angle of the viewer with respect to the screen surface of the autostereoscopic 3D display is 90°±Yθ, the left-eye image and the right-eye image are interchanged with each other, and the right-eye image and the left-eye image concurrently generated from the autostereoscopic 3D display are respectively received by the left eye and the right eye of the viewer.

2. The method of claim 1, wherein when the predetermined offset angle is 15 degrees, X=1, 3 and 5 and Y=2, 4 and 6, wherein when the real-time watching angle of the viewer with respect to the screen surface of the autostereoscopic 3D display is 90°±15X, the left-eye image and the right-eye image generated from the autostereoscopic 3D display are respectively received by the left eye and the right eye of the viewer, wherein when the real-time watching angle of the viewer with respect to the screen surface of the autostereoscopic 3D display is 90°±15Y, the left-eye image and the right-eye image are interchanged with each other, and the right-eye image and the left-eye image generated from the autostereoscopic 3D display are respectively received by the left eye and the right eye of the viewer.

3. The method of claim 1, further comprising:
defining an absolute zero position and an absolute zero angle of the autostereoscopic 3D display by a built-in gyroscope in the autostereoscopic 3D display while the viewer facing the autostereoscopic 3D display at 90 degrees relative to the screen surface of the autostereoscopic 3D display; and
capturing a real-time moving position relative to the absolute zero position and a real-time rotating angle relative to the absolute zero angle of the autostereoscopic 3D display by the built-in gyroscope to obtain the real-time watching angle of the viewer with respect to the screen surface of the autostereoscopic 3D display while the viewer facing the autostereoscopic 3D display at the real-time watching angle relative to the screen surface of the autostereoscopic 3D display.

4. The method of claim 1, wherein the autostereoscopic 3D display comprises:
a backlight module;
a LCD panel disposed on the backlight module, wherein the LCD panel has a plurality of pixels arranged in a matrix, each pixel is composed of at least three subpixels, and the at least three subpixels respectively are a red subpixel, a green subpixel and a blue subpixel; and
a 3D film disposed on the LCD panel, wherein the 3D film has a plurality of line pattern barriers, and three of the line pattern barriers are respectively defined as a first laminating alignment line, a second laminating alignment line and a third laminating alignment line;
wherein one of the at least three subpixels of the pixel adjacent to the upper-left corner of LCD panel is defined as a first laminating alignment point, one of the at least three subpixels of the pixel adjacent to the lower-left corner of LCD panel is defined as a second laminating alignment point, one of the at least three subpixels of the pixel adjacent to the upper-right corner of LCD panel is defined as a third laminating alignment point, and the first, the second and the third laminating alignment points are respectively and correspondingly aligned with the first, the second and the third laminating alignment lines.

5. The method of claim 4, wherein one of long lateral sides of the first laminating alignment line, one of long lateral sides of the second laminating alignment line and one of long lateral sides of the third laminating alignment line are respectively and horizontally aligned with one of long lateral sides of the first laminating alignment point, one of long lateral sides of the second laminating alignment point and one of long lateral sides of the third laminating alignment point.

6. The method of claim 4, wherein another one of the line pattern barriers is defined as a fourth laminating alignment line, one of the at least three subpixels of the pixel adjacent to the center of LCD panel is defined as a fourth laminating alignment point, and the fourth laminating alignment point is correspondingly aligned with the fourth laminating alignment line.

7. The method of claim 6, wherein one of long lateral sides of the first laminating alignment line, one of long lateral sides of the second laminating alignment line, one of long lateral sides of the third laminating alignment line and one of long lateral sides of the fourth laminating alignment line are respectively and horizontally aligned with one of long lateral sides of the first laminating alignment point, one of long lateral sides of the second laminating alignment point, one of long lateral sides of the third laminating alignment point and one of long lateral sides of the fourth laminating alignment point.

8. The method of claim 6, wherein yet another one of the line pattern barriers is defined as a fifth laminating alignment line, one of the at least three subpixels of the pixel adjacent to the lower-right corner of LCD panel is defined as a fifth laminating alignment point, and the fifth laminating alignment point is correspondingly aligned with the fifth laminating alignment line.

9. The method of claim 8, wherein one of long lateral sides of the first laminating alignment line, one of long lateral sides of the second laminating alignment line, one of long lateral sides of the third laminating alignment line, one of long lateral sides of the fourth laminating alignment line and one of long lateral sides of the fifth laminating alignment line are respectively and horizontally aligned with one of long lateral sides of the first laminating alignment point, one of long lateral sides of the second laminating alignment point, one of long lateral sides of the third laminating alignment point, one of long lateral sides of the fourth laminating alignment point and one of long lateral sides of the fifth laminating alignment point.

10. A method of providing a correct 3D image for a viewer at different watching angles of the viewer, comprising:
providing an autostereoscopic 3D display having a screen surface for concurrently generating a left-eye image and a right-eye image for the viewer;
capturing the position of a left eye and a right eye of the viewer by a built-in image capturing module on the autostereoscopic 3D display to obtain a real-time watching angle of the viewer with respect to the screen surface of the autostereoscopic 3D display; and
determining whether the real-time watching angle is in a first predetermined range or a second predetermined range, wherein the first and the second predetermined ranges are different;
wherein when the real-time watching angle of the viewer with respect to the screen surface of the autostereoscopic 3D display is in the first predetermined range, the left-eye image and the right-eye image concurrently generated from the autostereoscopic 3D display are respectively received by the left eye and the right eye of the viewer;
wherein when the real-time watching angle of the viewer with respect to the screen surface of the autostereoscopic 3D display is in the second predetermined range, the left-eye image and the right-eye image are interchanged with each other, and the right-eye image and the left-eye image concurrently generated from the autostereoscopic 3D display are respectively received by the left eye and the right eye of the viewer.
